(19) United States
(12) Patent Application Publication
(10) Pub. No.: US 2019/0177205 A1
(43) Pub. Date: Jun. 13, 2019

(54) GLASS

(71) Applicant: AGC INC., Chiyoda-ku (JP)

(72) Inventors: Akihiro Hishinuma, Fukushima (JP); Sohei Kawanami, Fukushima (JP); Masahiro Yamazaki, Fukushima (JP)

(73) Assignee: AGC INC., Chiyoda-ku (JP)

(21) Appl. No.: 16/204,139

(22) Filed: Nov. 29, 2018

(30) Foreign Application Priority Data
Dec. 8, 2017 (JP) 2017-236007
Sep. 11, 2018 (JP) 2018-169927

(51) Int. Cl. C03C 3/087; C03C 3/095; C03C 3/093; C03C 8/04; C03C 8/24

(52) U.S. Cl. CPC C03C 3/087; C03C 3/095; C03C 8/24; C03C 8/04; C03C 3/093

(57) ABSTRACT

A glass, substantially not including an alkali metal oxide and BaO, and including, in terms of mol % on the basis of oxides, 40 to 44% of SiO₂, 15 to 23% of MgO, 28 to 36% of CaO, and 5 to 10% of Al₂O₃, in which a total content of SiO₂, MgO, CaO, and Al₂O₃ is 97% or more, in which a molar ratio of CaO content to MgO content represented by CaO/MgO is 1.2 to 2.3.

### TECHNICAL FIELD

The present invention relates to SiO₂—MgO—CaO—Al₂O₃ based glass, a glass paste and a green sheet containing powder of the glass particularly suitable for use in sealing, bonding or the like between members selected from a group of members including metal or ceramics, a solid oxide fuel cell (hereinafter referred to as “SOFC”), and a method for manufacturing the SOFC.

### BACKGROUND ART

In the manufacturing of a composite including a metal member or a ceramic member as a constituent, a glass for sealing is widely used as a material for bonding/sealing for forming a composite by bonding/sealing those members. The glass for sealing is typically used in the form of a glass frit obtained by processing the glass into powder, a glass paste obtained by forming the glass frit into a paste, a green sheet (glass sheet) obtained by forming the glass frit into a sheet, or the like. Specifically, the glass for sealing is often used as a glass paste or a green sheet when bonding plane parts and is often used as a glass frit when bonding three-dimensional parts.

In recent years, a glass for sealing that can be used for sealing of a member of SOFC having a working temperature range of 700 to 1,000° C. is required, and as such a glass for sealing SOFC, for example, Patent Document 1 discloses a glass not containing much B₂O₃ and not having an inflection point (bend) in a thermal expansion curve of a fired body of powder thereof. Specifically, SiO₂—MgO—CaO—ZnO—Al₂O₃ based lead-free glass having a composition containing, in mol %, 35 to 41.5% of SiO₂, 8 to 25% of MgO, more than 27% and 35% or less of CaO, 0 to 2% of SrO, 0 to 4% of BaO, 5 to 15% of ZnO and 4.5 to 10% of Al₂O₃, with the total content of those components being 97% or more, in which when SrO and BaO are contained, the total content of those components is 2% or less, is disclosed.

### PRIOR ART DOCUMENT

### Patent Document

Patent Document 1: Japanese Patent No. 5365517

### SUMMARY OF THE INVENTION

### Problems that the Invention is to Solve

Patent Document 1 describes that when powder of the lead-free glass obtained is fired, a crystallized glass is formed. The crystallized glass does not have an inflection point in its thermal expansion curve and is therefore suitable for use as SOFC sealing material. However, the lead-free glass contains ZnO in an amount of 5% or more. ZnO easily causes oxygen defect and crystal defect and the like are generated by the oxygen defect. Therefore, when the lead-free glass is used as a sealing material, high reliability seal is not obtained and this has been the problem.

In Patent Document 1, a glass is unstable when the ZnO content is less than 5%, and a glass for sealing not containing ZnO and B₂O₃ or not containing much ZnO and B₂O₃ and not having an inflection point (bend) in a thermal expansion curve of a fired body of its powder has not been obtained.

An object of the present invention is to provide a glass suitable for use in sealing not containing ZnO and B₂O₃ or not containing much ZnO and B₂O₃, not having an inflection point (bend) in a thermal expansion curve of a fired body of its powder, and capable of imparting high reliability to a sealed product obtained, a glass paste using the glass, a green sheet using the glass, a solid oxide fuel cell using the glass, and a method for manufacturing the solid oxide fuel cell.

### Means for Solving the Problems

The present invention provides a glass, substantially not including an alkali metal oxide and BaO, and including, in terms of mol % on the basis of oxides, 40 to 44% of SiO₂, 15 to 23% of MgO, 28 to 36% of CaO, and 5 to 10% of Al₂O₃, in which a total content of SiO₂, MgO, CaO, and Al₂O₃ is 97% or more,

in which a molar ratio of CaO content to MgO content represented by CaO/MgO is 1.2 to 2.3 (hereinafter referred to as a “first glass”).

The present invention provides a glass, substantially not including an alkali metal oxide and BaO, and including, in terms of mol % on the basis of oxides, 34 to 40% of SiO₂, 14 to 20% of MgO, 28 to 36% of CaO, and 12 to 18% of Al₂O₃, in which a total content of SiO₂, MgO, CaO, and Al₂O₃ is 97% or more,

in which a molar ratio of CaO content to MgO content represented by CaO/MgO is 1.5 to 2.5 (hereinafter referred to as a “second glass”).

The present invention provides a glass, substantially not including an alkali metal oxide and TiO₂, and including, in terms of mol % on the basis of oxides, 42 to 47% of SiO₂, 14 to 19% of MgO, 29 to 36% of CaO, 3 to 7.5% of Al₂O₃, 0.3 to 5.5% of BaO, and 0 to 0.5% of SrO, in which a total content of SiO₂, MgO, CaO, Al₂O₃, BaO, and SrO is 97% or more,

in which a molar ratio of CaO content to MgO content represented by CaO/MgO is 2.0 to 2.3 (hereinafter referred to as a “third glass”).

The present invention provides a glass, substantially not including an alkali metal oxide and TiO₂, and including, in terms of mol % on the basis of oxides, 41 to 47% of SiO₂, 12.5 to 17.5% of MgO, 26 to 36% of CaO, more than 7.5% and 14% or less of Al₂O₃, and 0.3 to 4% of BaO, in which a total content of SiO₂, MgO, CaO, Al₂O₃, and BaO is 97% or more,

in which a molar ratio of CaO content to MgO content represented by CaO/MgO is 1.75 to 2.25 (hereinafter referred to as a “fourth glass”).

The present invention provides a glass paste including a powder of the first, second, third or fourth glass.

The present invention provides a green sheet including a powder of the first, second, third or fourth glass.

The present invention provides a method for manufacturing a solid oxide fuel cell, the method including a step of sealing members including ceramics or a metal to each other, in which the members are sealed to each other with a powder of the first, second, third or fourth glass.

The present invention provides a solid oxide fuel cell, including at least one sealed part in which members including ceramics or a metal are sealed to each other, in which at least one of the sealed part is sealed with a fired body obtained by firing a powder of the first, second, third or fourth glass.

In the present invention, the term “sealing members including ceramics or a metal to each other” includes the case of sealing the member including ceramics and the member including metal to each other.

### Advantageous Effect of the Invention

According to the present invention, a glass not containing ZnO and B₂O₃ or not containing much ZnO and B₂O₃, specifically not containing the total of those in a total amount exceeding 3 mol %, and not having an inflection point in a thermal expansion curve of a fired body of its powder or not substantially having an inflection point therein is obtained. The glass, glass paste and green sheet of the present invention are suitable for use in sealing, particularly sealing, bonding or the like between members selected from a group of members including metal or ceramics, and can impart high reliability to a sealed product obtained. According to the method for manufacturing a solid oxide fuel cell, a solid oxide fuel cell having high reliability can be provided by using the glass.

### MODE FOR CARRYING OUT THE INVENTION

The present invention provides a first glass, a second glass, a third glass and a fourth glass, having each composition described above. In the present specification, the term “the glass of the present invention” includes the first glass, the second glass, the third glass and the fourth glass.

The glass of the present invention is generally used in a form of powder. The glass of the present invention or its powder is typically used for sealing. In this case, the glass or its powder is fired at a temperature of, for example, 900 to 1,100° C. and typically 900 to 1,000° C., to form a fired body, and the fired body is a crystallized glass.

Typical crystals precipitated in the crystallized glass are high-expansive crystals, for example, CaO—MgO—SiO₂ based crystal such as diopside (Ca—MgO-2SiO₂), akermanite (2CaO—MgO-2SiO₂) and melilite, MgO—SiO₂ based crystal such as forsterite, CaO—SiO₂ based crystal, SiO₂—MgO—CaO—Al₂O₃ based crystal, and CaO—SiO₂—Al₂O₃ based crystal. Above all, a glass precipitating CaO—MgO—SiO₂ based crystal such as diopside, akermanite or melilite during firing is that transformation of a crystal phase during firing is small and strength of a bulk body (crystallized glass) after crystallization tends to be stabilized, and is therefore preferred.

The glass of the present invention is described below by reference to the case of using the glass in the sealing of SOFC constituent member as an example, but the use of the glass of the present invention is not limited to this. Specifically, the glass of the present invention is preferable in the uses requiring that an inflection point is not observed in a thermal expansion curve of a fired body of its powder or an inflection point is not substantially observed therein.

The glass of the present invention preferably has a softening point (Ts) of 820° C. or higher. When the Ts is lower than 820° C., the reaction to a member to be sealed is likely to become excessively large. The Ts is more preferably higher than 820° C. and typically 830° C. or higher. On the other hand, the Ts is preferably 920° C. or lower. When the Ts is higher than 920° C., fluidity of the glass is likely to decrease.

The glass of the present invention has a crystallization temperature (Tc) of typically 960 to 1,050° C.

Differential thermal analysis is conducted to read a fourth infection point and the value obtained is used as the Ts. The Tc is measured as follows. Differential thermal analysis is conducted to read a temperature of an exothermic peak that is at a side of higher temperature than the Ts and observed firstly (at the lowest temperature), and the temperature is used as the Tc.

(Tc−Ts) is preferably 110° C. or more. When the (Tc−Ts) is less than 110° C., fluidity becomes insufficient during firing and a space is formed between the fired body (crystallized glass) and an object to be sealed. As a result, desired sealing may not be performed. The (Tc−Ts) is more preferably 120° C. or more, still more preferably 130° C. or more and particularly preferably 140° C. or more.

The fired body (crystallized glass) obtained by firing the powder of the glass of the present invention in which a temperature is maintained at 950° C. for 1 hour, preferably has an average coefficient of linear expansion (α) in the range from 50 to 950° C. of 84×10⁻⁷ to 105×10⁻⁷/° C. When α is outside this range, matching in the expansion coefficient between the fired body and an object to be sealed is likely to be insufficient.

In measuring α of the fired body, a thermal expansion curve of the fired body in the range from 50 to 950° C. is measured. Temperature rising rate in the measurement of a is set to, for example, 10° C./min. The glass of the present invention is preferably that its thermal expansion curve has a straight line shape. A thermal expansion curve having a straight line shape means that a differential peak in the differential curve of the thermal expansion curve obtained by the following method is 0.01 μm/second or less.

A differential curve (horizontal axis: temperature, vertical axis: change of length of fired body per unit temperature) of the thermal expansion curve obtained above is prepared. When an inflection point is present in the thermal expansion curve, a peak and a trough, generally a peak, are generated in the temperature corresponding to the inflection point of the differential curve. When a peak or a trough is present in the differential curve, the largest value in heights of the peaks or depths of the troughs is read. When the differential peak is, for example, 1 μm/sec, this corresponds to that the maximum height of the peak or the maximum depth of the trough is 6 μm/° C. In reading a height of a peak or a depth of a trough, a spike-shaped peak or trough generated by, for example, that the fired body discontinuously moves during measurement is excluded. When the differential peak of the differential curve is 0.01 μm/sec or less, it can be considered that an inflection point is not substantially observed in the thermal expansion curve of the fired body of the glass powder.

The first glass does not substantially include an alkali metal oxide and BaO, and includes, in terms of mol % on the basis of oxides, 40 to 44% of SiO₂, 15 to 23% of MgO, 28 to 36% of CaO, and 5 to 10% of Al₂O₃, in which a total content of SiO₂, MgO, CaO, and Al₂O₃ is 97% or more, in which a molar ratio of CaO content to MgO content represented by CaO/MgO is 1.2 to 2.3. Since the first glass does not substantially contain BaO, the first glass is preferably used when the reaction between BaO and members including metal or ceramics is desired to be suppressed.

The second glass does not substantially include an alkali metal oxide and BaO, and includes, in terms of mol % on the basis of oxides, 34 to 40% of SiO₂, 14 to 20% of MgO, 28 to 36% of CaO, and 12 to 18% of Al₂O₃, in which a total content of SiO₂, MgO, CaO, and Al₂O₃ is 97% or more, in which a molar ratio of CaO content to MgO content represented by CaO/MgO is 1.5 to 2.5. The second glass does not substantially contain BaO and contains SiO₂ in an amount smaller than the amount in the first glass. Therefore, the second glass is preferably used when heat resistance is desired to be maintained under an environment where H₂O cuts a network of SiO₂.

The third glass does not substantially include an alkali metal oxide and TiO₂, and includes, in terms of mol % on the basis of oxides, 42 to 47% of SiO₂, 14 to 19% of MgO, 29 to 36% of CaO, 3 to 7.5% of Al₂O₃, 0.3 to 5.5% of BaO, and 0 to 0.5% of SrO, in which a total content of SiO₂, MgO, CaO, Al₂O₃, BaO, and SrO is 97% or more, in which a molar ratio of CaO content to MgO content represented by CaO/MgO is 2.0 to 2.3. The third glass contains BaO. Therefore, a thermal expansion coefficient of the glass phase remained without being crystallized after firing can be maintained high. Due to this, the third glass is preferably used when the thermal expansion coefficient thereof is desired to further match with a thermal expansion coefficient of members including metal or ceramics.

The fourth glass does not substantially include an alkali metal oxide and TiO₂, and includes, in terms of mol % on the basis of oxides, 41 to 47% of SiO₂, 12.5 to 17.5% of MgO, 26 to 36% of CaO, more than 7.5% and 14% or less of Al₂O₃, and 0.3 to 4% of BaO, in which a total content of SiO₂, MgO, CaO, Al₂O₃, and BaO is 97% or more, in which a molar ratio of CaO content to MgO content represented by CaO/MgO is 1.75 to 2.25.

The fourth glass contains BaO similar to the third glass. Therefore, a thermal expansion coefficient of the glass phase remained without being crystallized after firing can be maintained high. Due to this, the fourth glass is preferably used when the thermal expansion coefficient thereof is desired to further match with a thermal expansion coefficient of members including metal or ceramics and when the fluidity thereof at high temperature is desired to increase than that of the third glass.

In the present specification, the term “does not substantially contain” means that the recited component is not positively contained but is admitted to be contained in the form of unavoidable impurities. Furthermore, in the present specification, the term “from . . . to . . . ” showing the numerical range includes the numerical values indicated before and after the “to” as the lower limit and the upper limit.

The composition of the glass of the present invention is described below, and “mol %” is simply referred to as “%”.

SiO₂ is a component forming a network of the glass and improves stability of the glass during manufacturing the glass, thereby preventing crystallization of the glass. Therefore, SiO₂ is an essential component. When SiO₂-containing high-expansive crystals, for example, CaO—MgO—SiO₂ based crystal such as diopside (CaO—MgO-2 SiO₂), akermanite (2CaO—MgO-2 SiO₂) and melilite, and MgO—SiO₂ based crystal such as forsterite; Ca—SiO₂ based crystals; and the like are formed during firing the glass powder, SiO₂ becomes a constituent component of those crystals.

When the SiO₂ content exceeds 44.0% in the first glass, problems such as increase of Ts and deterioration of fluidity due to early initiation of crystallization occur. Furthermore, the problem that the glass is difficult to melt during melting occurs. When SiO₂ content is less than 40.0% in the first glass, stability of the glass decreases during manufacturing the glass and crystals are easy to be precipitated in the glass. For powder of the glass having the crystals precipitated therein, the crystallization is initiated early during firing and fluidity becomes insufficient. As a result, desired sealing or the like cannot be performed. Furthermore, the problem such as devitrification occurs. The SiO₂ content in the first glass is preferably 41.0 to 43.0% and more preferably 41.5 to 42.5%.

When SiO₂ content exceeds 40.0% in the second glass, the problem such as too low thermal expansion coefficient occurs. When SiO₂ content is 40.0% or less, the effect of maintaining heat resistance can be expected under an environment of SOFC and the like where H₂O is present at high temperature and the H₂O cuts the network of SiO₂. When the SiO₂ content is less than 34.0% in the second glass, stability of the glass is deteriorated during manufacturing the glass and crystals are easy to be precipitated in the glass. For powder of the glass having the crystals precipitated therein, the crystallization is initiated early during firing and fluidity becomes insufficient. As a result, desired sealing or the like cannot be performed. Furthermore, the problem such as devitrification occurs. The SiO₂ content in the second glass is preferably 35.0 to 40.0%, more preferably 36.0 to 39.0% and still more preferably 37.0 to 38.0%.

When the SiO₂ content exceeds 47.0% in the third glass, problems such as increase of Ts and deterioration of fluidity due to early initiation of crystallization occur. Furthermore, the problem that the glass is difficult to melt during melting occurs. When SiO₂ content is less than 42.0% in the third glass, stability of the glass decreases during manufacturing the glass and crystals are easy to be precipitated in the glass. For powder of the glass having the crystals precipitated therein, the crystallization is initiated early during firing and fluidity becomes insufficient. As a result, desired sealing or the like cannot be performed. The SiO₂ content in the third glass is preferably 42.0 to 46.0% and more preferably 43.0 to 45.0%.

When the SiO₂ content exceeds 47.0% in the fourth glass, problems such as increase of Ts and deterioration of fluidity due to early initiation of crystallization occur. Furthermore, the problem that the glass is difficult to melt during melting occurs. When SiO₂ content is less than 41.0% in the fourth glass, stability of the glass decreases during manufacturing the glass and crystals are easy to be precipitated in the glass. For powder of the glass having the crystals precipitated therein, the crystallization is initiated early during firing and fluidity becomes insufficient. As a result, desired sealing or the like cannot be performed. The SiO₂ content in the fourth glass is preferably 42.0 to 46.0% and more preferably 42.0 to 45.0%.

MgO is a component of MgO-containing high-expansive crystals such as MgO—SiO₂ based crystal and CaO—MgO—SiO₂ based crystal and is an essential component.

When the MgO content exceeds 23.0% in the first glass, glass stability is easy to decrease during manufacturing the glass, and crystals are rather difficult to precipitate during firing, which results that a degree of crystallinity of the fired body does not increase and a ratio of a residual glass phase to a crystal phase increases, whereby heat resistance is deteriorated. When the MgO content in the first glass is less than 15.0%, devitrification occurs, and crystals are difficult to precipitate during firing, which results that a degree of crystallinity of the fired body does not increase and a ratio of a residual glass phase to a crystal phase increases, whereby heat resistance is deteriorated. The MgO content in the first glass is preferably 16.0 to 20.0% and more preferably 17.0 to 18.0%.

When the MgO content exceeds 20.0% in the second glass, glass stability is easy to decrease during manufacturing the glass, and crystals are rather difficult to precipitate during firing, which results that a degree of crystallinity of the fired body does not increase and a ratio of a residual glass phase to a crystal phase increases, whereby heat resistance is deteriorated. When the MgO content in the second glass is less than 14.0%, devitrification occurs, and crystals are difficult to precipitate during firing, which results that a degree of crystallinity of the fired body does not increase and a ratio of a residual glass phase to a crystal phase increases, whereby heat resistance is deteriorated. The MgO content in the second glass is preferably 14.0 to 17.0%, more preferably 15.0 to 16.5% and still more preferably 15.5 to 16.0%.

When the MgO content exceeds 19.0% in the third glass, glass stability is easy to decrease during manufacturing the glass, and crystals are rather difficult to precipitate during firing, which results that a degree of crystallinity of the fired body does not increase and a ratio of a residual glass phase to a crystal phase increases, whereby heat resistance is deteriorated. When the MgO content in the third glass is less than 14.0%, devitrification occurs, and crystals are difficult to precipitate during firing, which results that a degree of crystallinity of the fired body does not increase and a ratio of a residual glass phase to a crystal phase increases, whereby heat resistance is deteriorated. The MgO content in the third glass is preferably 14.0 to 18.0% and more preferably 15.0 to 17.0%.

When the MgO content exceeds 17.5% in the fourth glass, glass stability is easy to decrease during manufacturing the glass, and crystals are rather difficult to precipitate during firing, which results that a degree of crystallinity of the fired body does not increase and a ratio of a residual glass phase to a crystal phase increases, whereby heat resistance is deteriorated. When the MgO content in the fourth glass is less than 12.5%, devitrification occurs, and crystals are difficult to precipitate during firing, which results that a degree of crystallinity of the fired body does not increase and a ratio of a residual glass phase to a crystal phase increases, whereby heat resistance is deteriorated. The MgO content in the fourth glass is preferably 14.5 to 17.5% and more preferably 15.0 to 17.0%.

CaO is a component of CaO-containing high-expansive crystals such as CaO—SiO₂ based crystal and CaO—MgO—SiO₂ based crystal and is an essential component.

When the CaO content exceeds 36.0% in the first glass, glass stability is easy to decrease during manufacturing the glass, and crystals are rather difficult to precipitate during firing, which results that a degree of crystallinity of the fired body does not increase and a ratio of a residual glass phase to a crystal phase increases, whereby heat resistance is deteriorated. When the CaO content in the first glass is less than 28.0%, devitrification occurs, and crystals are difficult to precipitate during firing, which results that a degree of crystallinity of the fired body does not increase and a ratio of a residual glass phase to a crystal phase increases, whereby heat resistance is deteriorated. The CaO content in the first glass is preferably 30.0 to 35.0% and more preferably 32.0 to 34.0%.

When the CaO content exceeds 36.0% in the second glass, glass stability is easy to decrease during manufacturing the glass, and crystals are rather difficult to precipitate during firing, which results that a degree of crystallinity of the fired body does not increase and a ratio of a residual glass phase to a crystal phase increases, whereby heat resistance is deteriorated. When the CaO content in the second glass is less than 28.0%, devitrification occurs, and crystals are difficult to precipitate during firing, which results that a degree of crystallinity of the fired body does not increase and a ratio of a residual glass phase to a crystal phase increases, whereby heat resistance is deteriorated. The CaO content in the second glass is preferably 28.0 to 34.0%, more preferably 29.0 to 33.0% and still more preferably 32.0 to 33.0%.

When the CaO content exceeds 36.0% in the third glass, glass stability is easy to decrease during manufacturing the glass, and crystals are rather difficult to precipitate during firing, which results that a degree of crystallinity of the fired body does not increase and a ratio of a residual glass phase to a crystal phase increases, whereby heat resistance is deteriorated. When the CaO content in the third glass is less than 29.0%, devitrification occurs, and crystals are difficult to precipitate during firing, which results that a degree of crystallinity of the fired body does not increase and a ratio of a residual glass phase to a crystal phase increases, whereby heat resistance is deteriorated. The CaO content in the third glass is preferably 32.0 to 35.0% and more preferably 33.0 to 35.0%.

When the CaO content exceeds 36.0% in the fourth glass, glass stability is easy to decrease during manufacturing the glass, and crystals are rather difficult to precipitate during firing, which results that a degree of crystallinity of the fired body does not increase and a ratio of a residual glass phase to a crystal phase increases, whereby heat resistance is deteriorated. When the CaO content in the fourth glass is less than 26.0%, devitrification occurs, and crystals are difficult to precipitate during firing, which results that a degree of crystallinity of the fired body does not increase and a ratio of a residual glass phase to a crystal phase increases, whereby heat resistance is deteriorated. The CaO content in the fourth glass is preferably 28.0 to 32.0% and more preferably 29.0 to 31.0%.

Al₂O₃ is a component useful to improve glass stability during manufacturing the glass and adjust Tc or maintain an adhesive force to metal, and is an essential component.

When the Al₂O₃ content exceeds 10% in the first glass, problems such as the increase of Ts and the decrease of a thermal expansion coefficient occur. When the Al₂O₃ content is less than 5% in the first glass, the glass becomes unstable and the problem such as devitrification occurs. The Al₂O₃ content in the first glass is preferably 6.0 to 9.0% and more preferably 7.0 to 8.0%.

When the Al₂O₃ content exceeds 18.0% in the second glass, the problems such as the excessive increase of Ts, excessive increase of the crystallization temperature and the decrease of a thermal expansion coefficient occur. When the Al₂O₃ content is less than 12.0% in the second glass, the problems such as deterioration of fluidity due to excessive decrease of the crystallization temperature and excessive increase of the thermal expansion coefficient occur. The Al₂O₃ content in the second glass is preferably 13.0 to 17.0% and more preferably 14.0 to 16.0%.

When the Al₂O₃ content exceeds 7.5% in the third glass, the problems such as excessive increase of Ts, excessive increase of the crystallization temperature and the decrease of the thermal expansion coefficient occur. When the Al₂O₃ content is less than 3.0% in the third glass, the problems such as deterioration of fluidity due to excessive decrease of the crystallization temperature and excessive increase of the thermal expansion coefficient occur. The Al₂O₃ content in the third glass is preferably 4.5 to 5.5%.

When the Al₂O₃ content exceeds 14.0% in the fourth glass, the problems such as excessive increase of Ts, excessive increase of the crystallization temperature and the decrease of the thermal expansion coefficient occur. When the Al₂O₃ content is 7.5% or less in the fourth glass, the problems such as deterioration of fluidity due to excessive decrease of the crystallization temperature and excessive increase of the thermal expansion coefficient occur. The Al₂O₃ content in the fourth glass is preferably 8.0 to 9.0%.

BaO is a component for adjusting the degree of crystallinity or fluidity, for improving an adhesive force to a metal member, and the like. BaO is present in a glass phase remaining without being crystallized after firing and maintains a thermal expansion coefficient of the residual glass phase high, thereby further matching the thermal expansion coefficient of the glass with that of members including metal or ceramics. On the other hand, BaO sometimes reacts with members including metal or ceramics. Therefore, BaO is not preferably contained when such a reaction is desired to be suppressed.

BaO is not substantially contained in the first and second glasses that are preferably used when the reaction between BaO and members including metal or ceramics is desired to be suppressed.

On the other hand, BaO is contained in the third and fourth glasses that are desired to further match the thermal expansion coefficient of the glass with members including metal or ceramics by maintaining the thermal expansion coefficient of the glass phase remained without being crystallized after firing high. The range of the Al₂O₃ content differs between the third glass and the fourth glass and therefore, the range of BaO content differs between those glasses.

In the third glass, the Al₂O₃ content is 3 to 7.5% and the BaO content is 0.3 to 5.5%. When the BaO content exceeds 5.5%, the thermal expansion coefficient is too high and the crystallization temperature is too high. On the other hand, when the BaO content is less than 0.3%, the effect of maintaining the thermal expansion coefficient of the glass phase remained without being crystallized high may be insufficient. The BaO content is preferably 0.5 to 2% and more preferably 0.5 to 1.0%.

In the fourth glass, the Al₂O₃ content is more than 7.5% and 14.0% or less and the BaO content is 0.3 to 4.0%. When the BaO content exceeds 4.0%, the thermal expansion coefficient is excessively high and the crystallization temperature is excessively high. On the other hand, when the BaO content is less than 0.3%, the effect of maintaining the thermal expansion coefficient of the glass phase remained without being crystallized high may be insufficient. The BaO content is preferably 0.5 to 2% and more preferably 0.5 to 1.0%.

In the first glass, a molar ratio CaO/MgO between CaO and MgO is 1.2 to 2.3. When the CaO/MgO ratio is less than 1.2 or exceeds 2.3, the crystallization is initiated too early during firing and fluidity decreases, making it difficult to perform the desired sealing and the like. The CaO/MgO ratio is preferably 1.5 to 2.2 and more preferably 1.7 to 2.1.

In the second glass, a molar ratio CaO/MgO between CaO and MgO is 1.5 to 2.5. When the CaO/MgO ratio is less than 1.5 or exceeds 2.5, the crystallization is initiated too early during firing and fluidity decreases, making it difficult to perform the desired sealing and the like. The CaO/MgO ratio is preferably 1.5 to 2.0.

In the third glass, a molar ratio CaO/MgO between CaO and MgO is 2.0 to 2.3. When the CaO/MgO ratio is less than 2.0 or exceeds 2.3, the crystallization is initiated too early during firing and fluidity decreases, making it difficult to perform the desired sealing and the like. The CaO/MgO ratio is preferably 2.0 to 2.1.

In the fourth glass, a molar ratio CaO/MgO between CaO and MgO is 1.75 to 2.25. When the CaO/MgO ratio is less than 1.75 or exceeds 2.25, the crystallization is initiated too early during firing and fluidity decreases, making it difficult to perform the desired sealing and the like. The CaO/MgO ratio is preferably 1.75 to 2.1 and more preferably 1.75 to 2.0.

SrO may be contained in the third glass in an amount of 0.5% or less for adjustment of thermal expandability or fluidity, or the like. When the SrO content in the third glass exceeds 0.5%, crystallization is initiated too early and fluidity decreases. Desirably SrO is not substantially contained in the third glass.

The glass of the present invention typically includes the components described above, and the total amount of those components is 97% or more in each of the first, second, third, and fourth glasses. The total amount thereof is preferably 98% or more and more preferably 99% or more. In other words, other components may be contained in the glass of the present invention in a range that does not impair the object of the present invention, and in this case, the total content of the other components is 3% or less, preferably 2% or less and typically 1.0% or less.

In the glass of the present invention, B₂O₃ is not typically contained, or when contained, the content thereof is preferably 1% or less. When the B₂O₃ content exceeds 1%, the proportion of a glass phase remained in a crystallized glass is increased, an inflection point is appeared in a thermal expansion curve, and strong shear stress and strain are generated at the interface of a seal part between an object to be sealed and a crystallized glass in a temperature region corresponding to the inflection point and this may lead to crack or peeling. Furthermore, B₂O₃ volatilizes during high temperature operation of SOFC and may contaminate the circumference. The B₂O₃ content is more preferably 0.5% or less and typically 0.2% or less. B₂O₃ is a component that may be contained when fluidity is desired to be improved during firing.

In the glass of the present invention, ZnO is not contained or is not contained in large amount for the following reasons. In the glass of the present invention, the ZnO content is preferably 2.0% or less and more preferably 1.0% or less, and still more preferably ZnO is not substantially contained.

ZnO is a component for the decrease of Ts, the adjustment of the degree of crystallinity, the improvement of an adhesive force to a metal member, and the like, but it is known that oxygen defect is generated at high temperature of 400° C. or higher. When the ZnO content exceeds 2.0%, crystal defect such as intercrystalline zinc or oxygen vacancy by the oxygen defect is generated and a seal having high reliability may not be obtained. When the crystal defect is generated, properties of crystals and residual glass in the crystallized glass change by being exposed to high temperature for a long period of time, which may cause the decrease of sealing strength and the change of an expansion coefficient. As a result, strong shear stress and strain are generated in the interface of a seal part between an object to be sealed and the crystallized glass, and this may lead to cracks and peeling. A component like ZnO is not preferred in SOFC member on the premise of using it at high temperature exceeding 700° C. for a long period of time.

The glass of the present invention does not substantially contain an alkali metal oxide such as Li₂O, Na₂O and K₂O. When the glass of the present invention is used to seal a constituent member of SOFC, thermally diffusible alkali metal ions diffuse in a ceramic member or a metal member and may remarkably deteriorate the properties of SOFC.

The third and fourth glasses do not substantially contain TiO₂. The reason for this is that when TiO₂ is contained in the third and fourth glasses, the crystallization temperature and thermal expansion coefficient excessively decrease.

In the first and second glasses, TiO₂ is a component that may be contained as component for adjusting the degree of crystallinity and the thermal expansion coefficient. However, when the TiO₂ content exceeds 0.5%, the crystallization temperature and the thermal expansion coefficient excessively decrease even in the first and second glasses. Therefore, when TiO₂ is contained in the first and second glasses, the content thereof is preferably 0.5% or less and more preferably 0.1% or less.

SrO may be contained in the first, second and fourth glasses for the adjustment of thermal expandability and fluidity, or the like. However, when the SrO content exceeds 1.0%, the crystallization is initiated too early and fluidity decreases. Therefore, the SrO content in the first, second and fourth glasses is preferably 1.0% or less and more preferably 0.5% or less, and desirably SrO is not substantially contained.

In the glass of the present invention, ZrO₂ is a component for adjusting the degree of crystallinity and the thermal expansion coefficient. When the ZrO₂ content is 0.2 to 2.0%, fluidity during firing is improved and the thermal expansion coefficient increases, which are preferred in some cases. When the ZrO₂ content exceeds 2.0%, the crystallization temperature is excessively high and the thermal expansion coefficient is excessively high. Therefore, when ZrO₂ is contained in the glass of the present invention, the content thereof is preferably 2.0% or less, more preferably 1.0% or less and still more preferably 0.5% or less.

Generally, oxides of rare earth elements, transition metals, and the like such as La, Y, Sc, Ge, Gd, Fe, Cu, V, Cr, Mn, Co, Ni and Mo are not desirably contained in the glass of the present invention for the reasons that the valence of those is easy to change, crystal structure and the like change, crystals different from the desired crystal are precipitated, and as a result, stable seal may not be obtained.

However, rare earth elements and transition metal oxides may be contained in the range such that stable seal is obtained, for example, in an amount of 0.1 to 3% for the purpose of improving fluidity. In particular, the addition of La₂O₃ can greatly improve fluidity of the glass. In the glass of the present invention, the La₂O₃ content is preferably 0.1 to 3%, more preferably 0.3 to 2% and still more preferably 0.5 to 1.5%.

Low melting point components such as Bi₂O₃, Sb₂O₃, TeO₂, AgO, P₂O₅ and WO diffuse in a ceramic member or a metal member and properties of SOFC may be remarkably deteriorated. Therefore, those components are desirably not contained in the glass of the present invention.

However, Bi₂O₃ may be contained in the glass of the present invention in an amount of 0.1 to 3.0% for the purpose of improving fluidity of the glass. The Bi₂O₃ content is preferably 0.3 to 1.5%.

SnO₂ may be contained in the glass of the present invention in an amount of 0.1 to 3.0% for the purpose of improving fluidity of the glass. The SnO₂ content is preferably 0.5 to 2.0%.

Preferably the glass of the present invention does not substantially contain lead, specifically PbO, in order to reduce load to environment.

The glass of the present invention is SiO₂—MgO—CaO—Al₂O₃ based glass having the compositions described above and has the properties that an inflection point is not present on a thermal expansion curve in a fired body of powder thereof and the generation of crystal defect can be suppressed, because of not containing ZnO and B₂O₃ or because of not containing those in large amount. Due to the properties, the glass of the present invention is particularly preferably used in sealing, bonding or the like between members selected from the group of members including metal and ceramics.

The glass of the present invention may have any form but generally has a powder form. A method for producing powder of the glass of the present invention is not particularly limited. For example, the powder can be obtained as follows. Raw material mixture in which the kind and proportion of each raw material is appropriately adjusted so as to be the composition range described above is melted, followed by cooling, and the glass obtained is pulverized to form powder.

The glass paste of the present invention is prepared by mixing the powder of the glass of the present invention with an organic vehicle or the like for imparting printability or the like. The organic vehicle is obtained by dissolving a binder such as ethyl cellulose in organic solvent such as α-terpineol. The green sheet of the present invention is obtained by forming the powder of the glass of the present invention into, for example, a glass paste and casting the glass paste into a sheet shape.

In the glass paste of the present invention, ceramic filler may be mixed with the powder of the glass of the present invention in order to adjust the fluidity, the thermal expansion coefficient, and the reactivity to a member including metal or ceramics. Examples of the ceramic filler include zirconium oxide, Y-containing stabilized zirconium oxide and Ca-containing stabilized zirconium oxide.

The mixing proportion of the ceramic filler is preferably 0.1 to 30 vol %, more preferably 0.3 to 20 vol % and still more preferably 0.5 to 10 vol %, based on the total volume of the powder of the glass and the ceramic filler. When the mixing proportion of the ceramic filler is too large, fluidity is deteriorated. On the other hand, when the mixing proportion is too small, the effect of adjusting the fluidity, the thermal expansion coefficient, and the reactivity to a member including metal or ceramics is not obtained.

The glass powder and the ceramic filler preferably have a particle size of about 0.5 μm to 45 μm. When the particle size is too small, the crystallization can be initiated early, but the crystallization may be initiated too early and fluidity may be deteriorated. On the other hand, when the particle size is too large, fluidity can be relatively maintained, but those may not be used when the seal thickness is small, depending on the structure of SOFC or the like.

In the present specification, the particle size shows 50% particle diameter of volume basis in cumulative particle size distribution and specifically shows a particle diameter when an integrated quantity occupies 50% in volume basis in a cumulative particle size distribution curve of a particle size distribution measured by using laser diffraction/scattering particle size distribution measuring apparatus.

The glass paste of the present invention is applied to the part to be sealed such as the surface of a ceramic member and a metal member constituting a fuel manifold and a cell of SOFC and then fired to form a crystallized glass (fired body), thereby sealing the desired constituent member. Furthermore, the constituent member may be sealed by using the green sheet of the present invention.

A method for manufacturing SOFC by sealing a ceramic member or a metal member of SOFC by using the glass paste of the present invention or the green sheet of the present invention in the above manner is the manufacturing method of SOFC of the present invention, and the SOFC thus manufactured is the SOFC of the present invention.

### EXAMPLES

The present invention is described in detail below by reference to Examples, but the invention is not limited to those Examples.

### Production of Glass Powder

Each raw material was prepared and mixed so as to have the composition shown in terms of mol % in the column of composition in Tables 1 to 7, the resulting each mixture was melted by using a platinum crucible in an electric furnace at 1,450 to 1,550° C. for 1 hour, the resulting each melt was casted into a thin sheet-like glass, the glass was pulverized with a ball mill and coarse particles in the pulverized material was removed with 150 mesh sieve to obtain glass powder.

Examples 1-1 to 1-12 and 1-17 to 1-31 are Working Examples of the first glass, and Examples 1-13 to 1-16 are Comparative Examples of the first glass. Examples 2-1 to 2-10 are Working Examples of the second glass and Examples 2-11 to 2-18 are Comparative Examples of the second glass. Examples 3-1 to 3-8 are Working Examples of the third glass and Examples 3-9 to 3-13 are Comparative Examples of the third glass. Examples 4-1 to 4-8 are Working Examples of the fourth glass and Examples 4-9 and 4-10 are Comparative Examples of the fourth glass.

### Evaluation

### Differential Thermal Analysis

Tg (unit: ° C.), Ts (unit: ° C.) and Tc (unit: ° C.) of each glass powder were measured by using a differential thermal analyzer. The results obtained are shown in Tables. In addition to those, Tc−Ts is also shown in Tables.

### Measurement of Thermal Expansion Curve

Each glass powder was molded, each molded body was maintained at 950° C. for 1 hours to fire it, each fired body obtained was processed into a columnar shape having a diameter of 5±0.5 mm and a length of 2±0.05 cm, a thermal expansion curve (horizontal axis: temperature, vertical axis: length of fired body) in the range from 50 to 950° C. was measured under the condition of temperature rising rate: 10° C./min by a thermal expansion meter, Thermo plus 2 system TMA8310 manufactured by Rigaku Corporation, and an average coefficient of linear expansion (α) (unit: 10⁻⁷/° C.) was calculated. The results obtained are shown in Tables.

A differential curve of the thermal expansion curve obtained above was prepared and a differential peak was obtained by the above method. The differential peak was 0.01 μm/second or less in each of the glasses of Working Examples and the glasses of Comparative Examples obtained above and an inflection point (bend) was not observed in the thermal expansion curve of the fired body. As indicated in the Comparative Examples of Japanese Patent No. 5365517, the inflection point is confirmed in each of the glasses containing B₂O₃.

### Fluidity

Fluidity of each glass powder was evaluated as follows. 3 g of glass powder was press-molded to prepare a sample (flow button) having a diameter of ½ inch (=12.7 mm), the temperature of the sample was elevated to 950° C. to fluidize the sample and fluidity thereof was evaluated. A diameter (unit: mm) of the sample after elevating the temperature was measured and indicated as “FB diameter” in the Tables.

The fluidity was evaluated from the “FB diameter” obtained according to the following criteria. The results obtained are shown in the Tables.

### Evaluation Criteria of Fluidity

Less than 11.5 mm: D (Stable sealing could not be performed even though a load is present)

11.5 mm or more and less than 12 mm: C (stable sealing could be performed when a load is sufficient)

12 mm or more and less than 13 mm: B (stable sealing could be performed even though a load is not present)

13 mm or more: A (sealing could be performed further stably)

Diopside (CaO—MgO-2SiO₂) and akermanite (2CaO—MgO-2SiO₂) were precipitated in the fired bodies obtained by firing the glass powder of Example 1-2, Example 3-1 and Example 4-1. Devitrification was confirmed in Example 1-16, Example 2-17 and Example 2-18. The mark “-” in the Tables means that the data was not measured. In Example 2-15, Tc exceeded 1,050° C., was more than the measurement range and therefore could not be measured.

TABLE 1

| | | Examples | | | | | | | |
|---|---|---|---|---|---|---|---|---|---|
| | | Working Examples | | | | | | | |
| | | 1-1 | 1-2 | 1-3 | 1-4 | 1-5 | 1-6 | 1-7 | 1-8 |
| mol % | SiO₂ | 43.9 | 42.0 | 40.0 | 42.0 | 42.0 | 42.0 | 42.0 | 42.0 |
| | MgO | 16.6 | 16.6 | 17.3 | 17.7 | 15.4 | 16.7 | 16.3 | 18.8 |
| | CaO | 34.2 | 34.2 | 35.5 | 33.1 | 35.4 | 33.3 | 32.7 | 32.0 |
| | Al₂O₃ | 5.3 | 7.2 | 7.2 | 7.2 | 7.2 | 8.0 | 9.0 | 7.2 |
| | CaO/MgO | 2.1 | 2.1 | 2.1 | 1.9 | 2.3 | 2.0 | 2.0 | 1.7 |

| | | | | | | | | |
|---|---|---|---|---|---|---|---|---|
| Tg | 743 | 747 | 749 | 745 | 758 | 746 | 752 | 745 |
| Ts | 859 | 864 | 862 | 864 | 868 | 866 | 870 | 864 |
| Tc | 971 | 1003 | 981 | 1009 | 992 | 1014 | 1012 | 1008 |
| Tc-Ts | 146 | 173 | 150 | 173 | 165 | 180 | 173 | 178 |
| α | 97 | 94 | 95 | 98 | 96 | 93 | 95 | 100 |
| FB diameter (mm) | 11.6 | 13.3 | 11.7 | 13.7 | 12.2 | 14.0 | 13.4 | 13.5 |
| Fluidity | C | A | C | A | B | A | A | A |

TABLE 2

| | | Examples | | | | | | | |
|---|---|---|---|---|---|---|---|---|---|
| | | Working Examples | | | | Comparative Examples | | | |
| | | 1-9 | 1-10 | 1-11 | 1-12 | 1-13 | 1-14 | 1-15 | 1-16 |
| mol % | SiO₂ | 42.0 | 41.0 | 42.0 | 42.0 | 50.0 | 45.0 | 45.0 | 34.7 |
| | MgO | 19.9 | 16.3 | 21.2 | 22.6 | 14.3 | 13.3 | 11.7 | 20.0 |
| | CaO | 30.9 | 32.7 | 29.6 | 28.2 | 28.5 | 26.7 | 23.3 | 40.0 |
| | Al₂O₃ | 7.2 | 10.0 | 7.2 | 7.2 | 7.2 | 15.0 | 20.0 | 5.3 |
| | CaO/MgO | 1.6 | 2.0 | 1.4 | 1.3 | 2.0 | 2.0 | 2.0 | 2.0 |

| | | | | | | | | |
|---|---|---|---|---|---|---|---|---|
| Tg | 744 | 754 | 743 | 740 | 750 | 764 | 791 | — |
| Ts | 865 | 876 | 861 | 862 | 875 | 896 | 923 | — |
| Tc | 1009 | 1035 | 1004 | 994 | 991 | 1024 | 1020 | — |
| Tc-Ts | 181 | 197 | 178 | 170 | 117 | 128 | 97 | — |
| α | 99 | 89 | 102 | 97 | 89 | 71 | 62 | — |
| FB diameter (mm) | 13.8 | 14.5 | 13.5 | 12.3 | 11.3 | 11.2 | 10.6 | — |
| Fluidity | A | A | A | B | D | D | D | — |

TABLE 3

| | | Examples | | | | | | | |
|---|---|---|---|---|---|---|---|---|---|
| | | Working Examples | | | | | | | |
| | | 1-17 | 1-18 | 1-19 | 1-20 | 1-21 | 1-22 | 1-23 | 1-24 |
| mol % | SiO₂ | 41.6 | 41.6 | 41.1 | 41.1 | 42.0 | 42.0 | 41.7 | 41.7 |
| | MgO | 21.0 | 21.0 | 20.8 | 20.8 | 21.2 | 21.2 | 21.1 | 21.1 |
| | CaO | 29.3 | 29.3 | 29.0 | 29.0 | 29.6 | 29.6 | 29.5 | 29.5 |
| | SrO | 0.0 | 0.0 | 0.0 | 0.0 | 0.0 | 0.0 | 0.0 | 0.0 |
| | Al₂O₃ | 7.1 | 7.1 | 7.1 | 7.1 | 6.2 | 6.7 | 6.7 | 7.2 |
| | ZrO₂ | 1.0 | 0.0 | 2.0 | 0.0 | 0.0 | 0.0 | 0.0 | 0.0 |
| | Bi₂O₃ | 0.0 | 0.0 | 0.0 | 0.0 | 0.0 | 0.0 | 0.0 | 0.0 |
| | La₂O₃ | 0.0 | 0.0 | 0.0 | 0.0 | 1.0 | 0.5 | 1.0 | 0.5 |
| | SnO₂ | 0.0 | 1.0 | 0.0 | 2.0 | 0.0 | 0.0 | 0.0 | 0.0 |
| | CaO/MgO | 1.40 | 1.40 | 1.39 | 1.39 | 1.40 | 1.40 | 1.40 | 1.40 |

| | | | | | | | | |
|---|---|---|---|---|---|---|---|---|
| Tg | 747 | 752 | 751 | 758 | 738 | 742 | 742 | 741 |
| Ts | 862 | 868 | 870 | 880 | 870 | 868 | 871 | 865 |
| Tc | 1008 | 1004 | 999 | 991 | 1004 | 1009 | 1000 | 997 |
| Tc-Ts | 146 | 136 | 129 | 111 | 134 | 141 | 129 | 132 |
| α | 96 | 99 | 99 | 98 | 101 | 101 | 100 | 101 |
| FB diameter (mm) | 13.2 | 12.6 | 12.2 | 11.7 | 13.8 | 13.9 | 13.4 | 12.8 |
| Fluidity | A | B | B | C | A | A | A | B |

TABLE 4

| | | Examples | | | | | | |
|---|---|---|---|---|---|---|---|---|
| | | Working Examples | | | | | | |
| | | 1-25 | 1-26 | 1-27 | 1-28 | 1-29 | 1-30 | 1-31 |
| mol % | SiO₂ | 41.6 | 41.1 | 40.8 | 41.7 | 41.6 | 41.7 | 41.6 |
| | MgO | 21.0 | 20.8 | 20.6 | 21.1 | 21.0 | 21.1 | 21.0 |
| | CaO | 29.3 | 29.0 | 28.7 | 29.5 | 29.3 | 29.5 | 29.3 |
| | SrO | 0.0 | 0.0 | 0.0 | 0.0 | 0.0 | 0.5 | 1.0 |
| | Al₂O₃ | 7.1 | 7.1 | 7.0 | 7.2 | 7.1 | 7.2 | 7.1 |
| | ZrO₂ | 0.0 | 0.0 | 0.0 | 0.0 | 0.0 | 0.0 | 0.0 |
| | Bi₂O₃ | 0.0 | 0.0 | 0.0 | 0.5 | 1.0 | 0.0 | 0.0 |
| | La₂O₃ | 1.0 | 2.0 | 2.9 | 0.0 | 0.0 | 0.0 | 0.0 |
| | SnO₂ | 0.0 | 0.0 | 0.0 | 0.0 | 0.0 | 0.0 | 0.0 |
| | CaO/MgO | 1.40 | 1.39 | 1.39 | 1.40 | 1.40 | 1.40 | 1.40 |

| | | | | | | | |
|---|---|---|---|---|---|---|---|
| Tg | 745 | 747 | 753 | 740 | 729 | 742 | 739 |
| Ts | 869 | 875 | 873 | 862 | 858 | 863 | 866 |
| Tc | 1025 | 1009 | 1004 | 990 | 993 | 1000 | 1007 |
| Tc-Ts | 156 | 135 | 131 | 127 | 136 | 138 | 141 |
| α | 100 | 95 | 93 | 98 | 97 | 100 | 99 |
| FB diameter (mm) | 14.6 | 13.9 | 12.0 | 12.8 | 13.3 | 13.2 | 13.8 |
| Fluidity | A | A | B | B | A | A | A |

TABLE 5

| | | Examples | | | | | | | | |
|---|---|---|---|---|---|---|---|---|---|---|
| | | Working Examples | | | | | | | | |
| | | 2-1 | 2-2 | 2-3 | 2-4 | 2-5 | 2-6 | 2-7 | 2-8 | 2-9 |
| mol % | SiO₂ | 37.5 | 40.0 | 37.5 | 35.0 | 40.0 | 37.5 | 37.5 | 37.5 | 37.5 |
| | MgO | 16.7 | 15.8 | 15.8 | 16.7 | 15.0 | 15.0 | 19.2 | 17.9 | 15.6 |
| | CaO | 33.3 | 31.7 | 31.7 | 33.3 | 30.0 | 30.0 | 30.8 | 32.1 | 34.4 |
| | Al₂O₃ | 12.5 | 12.5 | 15.0 | 15.0 | 15.0 | 17.5 | 12.5 | 12.5 | 12.5 |
| | CaO/MgO | 2.0 | 2.0 | 2.0 | 2.0 | 2.0 | 2.0 | 1.6 | 1.8 | 2.2 |

| | | | | | | | | | |
|---|---|---|---|---|---|---|---|---|---|
| Tg | 762 | 759 | 763 | 764 | 765 | 773 | 754 | 759 | 768 |
| Ts | 881 | 879 | 882 | 885 | 893 | 902 | 878 | 880 | 885 |
| Tc | 1027 | 1038 | 1036 | 1015 | 1047 | 1031 | 1027 | 1030 | 1029 |
| Tc-Ts | 147 | 160 | 154 | 130 | 154 | 130 | 149 | 150 | 144 |
| α | 92 | 86 | 97 | 94 | 94 | 96 | 97 | 97 | 94 |
| FB diameter (mm) | 13.0 | 14.0 | 13.1 | 12.2 | 13.1 | 12.0 | 13.8 | 13.8 | 12.8 |
| Fluidity | A | A | A | B | A | B | A | A | B |

TABLE 6

| | | Examples | | | | | | | | |
|---|---|---|---|---|---|---|---|---|---|---|
| | | Working Ex. | Comparative Examples | | | | | | | |
| | | 2-10 | 2-11 | 2-12 | 2-13 | 2-14 | 2-15 | 2-16 | 2-17 | 2-18 |
| mol % | SiO₂ | 37.5 | 30.0 | 25.0 | 30.0 | 35.0 | 40.0 | 42.5 | 27.5 | 27.5 |
| | MgO | 14.7 | 20.0 | 20.0 | 18.3 | 15.0 | 11.7 | 14.7 | 19.2 | 15.8 |
| | CaO | 35.3 | 40.0 | 40.0 | 36.7 | 30.0 | 23.3 | 29.3 | 38.3 | 31.7 |
| | Al₂O₃ | 12.5 | 10.0 | 15.0 | 15.0 | 20.0 | 25.0 | 13.5 | 15.0 | 25.0 |
| | CaO/MgO | 2.4 | 2.0 | 2.0 | 2.0 | 2.0 | 2.0 | 2.0 | 2.0 | 2.0 |

| | | | | | | | | | |
|---|---|---|---|---|---|---|---|---|---|
| Tg | 763 | 759 | 764 | 767 | 775 | 803 | 762 | — | — |
| Ts | 886 | 868 | 878 | 883 | 902 | 937 | 890 | — | — |
| Tc | 1036 | 904 | 952 | 942 | 1033 | — | 1036 | — | — |
| Tc-Ts | 150 | 36 | 74 | 59 | 131 | — | 145 | — | — |
| α | 90 | 109 | 106 | 96 | 98 | 66 | 83 | — | — |
| FB diameter | 12.2 | 10.5 | 10.4 | 10.5 | 11.0 | 10.9 | 12.8 | — | — |
| (mm) | | | | | | | | | |
| Fluidity | B | D | D | D | D | D | B | — | — |

TABLE 7

| | | Examples | | | | | | |
|---|---|---|---|---|---|---|---|---|
| | | Working Examples | | | | | | |
| | | 3-1 | 3-2 | 3-3 | 3-4 | 3-5 | 3-6 | 3-7 |
| mol % | SiO₂ | 43.9 | 44.0 | 46.2 | 43.9 | 43.9 | 43.7 | 43.9 |
| | ZnO | 0.0 | 0.0 | 0.0 | 2.0 | 0.0 | 0.0 | 0.0 |
| | MgO | 16.6 | 15.3 | 15.3 | 16.1 | 16.6 | 16.5 | 16.1 |
| | CaO | 33.2 | 30.6 | 30.6 | 32.2 | 33.2 | 33.0 | 33.7 |
| | BaO | 1.0 | 5.2 | 3.0 | 0.5 | 0.5 | 0.5 | 1.0 |
| | SrO | 0.0 | 0.0 | 0.0 | 0.0 | 0.5 | 0.5 | 0.0 |
| | Al₂O₃ | 5.3 | 4.9 | 4.9 | 5.3 | 5.3 | 5.3 | 5.3 |
| | TiO₂ | 0.0 | 0.0 | 0.0 | 0.0 | 0.0 | 0.0 | 0.0 |
| | ZrO₂ | 0.0 | 0.0 | 0.0 | 0.0 | 0.0 | 0.5 | 0.0 |
| | CaO/MgO | 2.0 | 2.0 | 2.0 | 2.0 | 2.0 | 2.0 | 2.1 |

| | | | | | | | |
|---|---|---|---|---|---|---|---|
| Tg | 739 | 742 | 739 | 735 | 743 | 747 | 744 |
| Ts | 860 | 862 | 863 | 849 | 860 | 862 | 858 |
| Tc | 990 | 974 | 982 | 987 | 971 | 987 | 996 |
| Tc-Ts | 131 | 112 | 120 | 137 | 112 | 125 | 138 |
| α | 96 | 95 | 90 | 98 | 97 | 99 | 95 |
| FB diameter (mm) | 12.7 | 11.9 | 12.2 | 12.9 | 11.8 | 12.0 | 13.0 |
| Fluidity | B | C | B | B | C | B | A |

TABLE 8

| | | Examples | | | | | |
|---|---|---|---|---|---|---|---|
| | | Working Ex. | Comparative Examples | | | | |
| | | 3-8 | 3-9 | 3-10 | 3-11 | 3-12 | 3-13 |
| mol % | SiO₂ | 43.9 | 44.8 | 43.5 | 40.1 | 43.5 | 45.7 |
| | ZnO | 0.0 | 0.0 | 0.0 | 0.0 | 0.0 | 0.0 |
| | MgO | 15.6 | 16.6 | 16.4 | 18.3 | 16.4 | 16.6 |
| | CaO | 34.2 | 32.3 | 32.9 | 35.9 | 32.9 | 31.4 |
| | BaO | 1.0 | 1.0 | 0.5 | 0.5 | 1.0 | 1.0 |
| | SrO | 0.0 | 0.0 | 0.5 | 0.0 | 1.0 | 0.0 |
| | Al₂O₃ | 5.3 | 5.3 | 5.2 | 5.3 | 5.2 | 5.3 |
| | TiO₂ | 0.0 | 0.0 | 0.5 | 0.0 | 0.0 | 0.0 |
| | ZrO₂ | 0.0 | 0.0 | 0.5 | 0.0 | 0.0 | 0.0 |
| | CaO/MgO | 2.2 | 1.9 | 2.0 | 2.0 | 2.0 | 1.9 |

| | | | | | | |
|---|---|---|---|---|---|---|
| Tg | 746 | 741 | 747 | 750 | 736 | 740 |
| Ts | 860 | 859 | 860 | 857 | 864 | 861 |
| Tc | 985 | 932 | 947 | 954 | 944 | 969 |
| Tc-Ts | 125 | 73 | 86 | 98 | 80 | 109 |
| α | 97 | 95 | 97 | 98 | 94 | 98 |
| FB diameter (mm) | 11.8 | 10.5 | 10.8 | 11.2 | 10.8 | 11.3 |
| Fluidity | C | D | D | D | D | D |

TABLE 9

| | | Examples | | | | | | | | | |
|---|---|---|---|---|---|---|---|---|---|---|---|
| | | Working Examples | | | | | | | | Comp. Ex. | |
| | | 4-1 | 4-2 | 4-3 | 4-4 | 4-5 | 4-6 | 4-7 | 4-8 | 4-9 | 4-10 |
| mol % | SiO₂ | 42.6 | 44.4 | 44.0 | 44.0 | 44.0 | 46.0 | 42.0 | 42.0 | 44.0 | 44.0 |
| | ZnO | 0.0 | 0.0 | 0.0 | 0.0 | 0.0 | 0.0 | 0.0 | 0.0 | 0.0 | 0.0 |
| | MgO | 16.1 | 16.1 | 14.7 | 16.4 | 14.4 | 14.7 | 15.2 | 14.5 | 13.3 | 14.0 |
| | CaO | 32.2 | 30.5 | 29.3 | 29.6 | 31.6 | 29.3 | 30.3 | 29.0 | 26.7 | 28.0 |
| | BaO | 1.0 | 1.0 | 3.0 | 1.0 | 1.0 | 1.0 | 1.0 | 1.0 | 1.0 | 5.0 |
| | SrO | 0.0 | 0.0 | 0.0 | 0.0 | 0.0 | 0.0 | 0.0 | 0.0 | 0.0 | 0.0 |
| | Al₂O₃ | 8.1 | 8.1 | 9.0 | 9.0 | 9.0 | 9.0 | 11.5 | 13.5 | 15.0 | 9.0 |
| | TiO₂ | 0.0 | 0.0 | 0.0 | 0.0 | 0.0 | 0.0 | 0.0 | 0.0 | 0.0 | 0.0 |
| | ZrO₂ | 0.0 | 0.0 | 0.0 | 0.0 | 0.0 | 0.0 | 0.0 | 0.0 | 0.0 | 0.0 |
| | CaO/MgO | 2.00 | 1.89 | 2.00 | 1.80 | 2.20 | 2.00 | 2.00 | 2.00 | 2.00 | 2.00 |

| | | | | | | | | | | |
|---|---|---|---|---|---|---|---|---|---|---|
| Tg | 749 | 744 | 750 | 751 | 755 | 753 | 758 | 762 | 767 | 751 |
| Ts | 867 | 871 | 873 | 870 | 872 | 876 | 883 | 894 | 897 | 874 |
| Tc | 1009 | 1003 | 1029 | 1019 | 1006 | 1008 | 1046 | 1035 | 1045 | 1012 |
| Tc-Ts | 142 | 132 | 156 | 149 | 133 | 131 | 163 | 142 | 148 | 138 |
| α | 96 | 94 | 94 | 95 | 96 | 89 | 84 | 89 | 75 | 95 |
| FB diameter | 13.4 | 12.3 | 13.1 | 13.6 | 12.7 | 12.2 | 14.4 | 12.9 | 12.1 | 11.2 |
| (mm) | | | | | | | | | | |
| Fluidity | A | B | A | A | B | B | A | B | B | D |

Although the present invention has been described in detail and by reference to the specific embodiments, it is apparent to one skilled in the art that various modifications or changes can be made without departing the spirit and scope of the present invention. This application is based on Japanese Patent Application (No. 2017-236007) filed on Dec. 8, 2017 and Japanese Patent Application (No. 2018-169927) filed on Sep. 11, 2018, and the disclosures of which are incorporated herein by reference in its entity. Furthermore, all references cited herein are incorporated in their entirety.

The glass of the present invention can be used in the manufacturing of SOFC and the manufacturing of an oxygen generator.

1. A glass, substantially not comprising an alkali metal oxide and BaO, and comprising, in terms of mol % on the basis of oxides, 40 to 44% of SiO₂, 15 to 23% of MgO, 28 to 36% of CaO, and 5 to 10% of Al₂O₃, in which a total content of SiO₂, MgO, CaO, and Al₂O₃ is 97% or more,
wherein a molar ratio of CaO content to MgO content represented by CaO/MgO is 1.2 to 2.3.

2. The glass according to claim 1, substantially not comprising any of oxides of La, Y, Sc, Ge, Gd, Fe, Cu, V, Cr, Mn, Co, Ni and Mo.

3. The glass according to claim 1, further comprising 0.1 to 3 mol % of La₂O₃.

4. The glass according to claim 1, having a softening point of higher than 820° C.

5. The glass according to claim 1, wherein a fired body obtained by firing a powder of the glass at 950° C. has an average coefficient of linear expansion in the range from 50 to 950° C. of 84×10⁻⁷ to 105×10⁻⁷/° C.

6. The glass according to claim 1, comprising 2 mol % or less of ZnO.

7. The glass according to claim 1, comprising 1 mol % or less of B₂O₃.

8. The glass according to claim 1, substantially not comprising a lead.

9. The glass according to claim 1, wherein a fired body obtained by firing a powder of the glass at 900° C. to 1100° C. has CaO—MgO—SiO₂ based crystal precipitated therein.
